(19) United States
(12) Patent Application Publication
(10) Pub. No.: US 2025/0196023 A1
(43) Pub. Date: Jun. 19, 2025

(54) COLUMN AND ADSORPTION APPARATUS

(71) Applicant: HOYA TECHNOSURGICAL CORPORATION, Tokyo (JP)

(72) Inventor: Tomohiko YOSHITAKE, Tokyo (JP)

(73) Assignee: HOYA TECHNOSURGICAL CORPORATION, Tokyo (JP)

(21) Appl. No.: 18/845,548

(22) PCT Filed: Mar. 11, 2022
(86) PCT No.: PCT/JP2022/010910

§ 371 Date: Sep. 10, 2024

(51) Int. Cl. B01D 15/22; B01D 15/42; B01J 20/04; B01J 20/28; B01J 20/281; G01N 30/60

(52) U.S. Cl. CPC B01D 15/22; B01D 15/424; B01J 20/048; B01J 20/28052; B01J 20/281; G01N 30/6004; G01N 30/6069; B01J 2220/58

(57) ABSTRACT

Object: To provide a column for use in an adsorption apparatus capable of purifying and isolating a substance to be adsorbed, which is contained in a sample solution, at an excellent purification rate, and an adsorption apparatus including the column. Resolution means: A column 2 of the present invention includes: a column main body 21; filter members 4 and 5 (first partition wall and second partition wall) that define an adsorbent filling space 20; a lid 26 (first lid) having a flow path 41 (first flow path) defining a space 262 (first space) between the lid 26 and the filter member 4; a lid 27 (second lid) having a flow path 51 (second flow path) defining a space 272 (second space) between the lid 27 and the filter member 5. The lids 26 and 27 have first and second lid surfaces facing the spaces 262 and 272, respectively. An angle θ1 [°] formed by a first partition wall surface of the filter member 4 and the first lid surface, and an angle θ2 formed by a second partition wall surface of the filter member 5 and the second lid surface satisfy at least one of 7.5°≤θ1≤20° and 7.5°≤θ2≤20°.

### TECHNICAL FIELD

The present invention relates to a column for use in an adsorption apparatus capable of purifying and isolating a substance to be adsorbed, which is contained in a sample solution, at an excellent purification rate, and to an adsorption apparatus that includes the column.

### BACKGROUND ART

In recent years, hydroxyapatite, because of, for example, its high biocompatibility and excellent safety, has been widely used as a material for stationary phase of chromatography, i.e., an adsorbent, for use in purifying and isolating bio-based pharmaceuticals such as antibodies and vaccines as substances to be adsorbed.

As an adsorption apparatus including, as an adsorbent, a powder of hydroxyapatite (HAP), which is used as a material for stationary phase of chromatography, the following configuration, for example, is known.

Specifically, an adsorption apparatus has been proposed in which a green powder formed from particles containing secondary particles of hydroxyapatite, or a sintered powder obtained by firing (sintering) the green powder is charged into an adsorbent filling space included in a column main body or the like of a column, so that the green powder or the sintered powder is provided as a material for stationary phase (adsorbent) (see, for example, Patent Document 1).

When a sample solution is supplied to the adsorption apparatus having such a configuration, the substance to be adsorbed as an isolation material contained in the sample solution specifically adsorbs with its inherent adsorption force (carrying force), and is flowed out of the column in a state in which the substance to be adsorbed is eluted in a fraction different from that for contamination substances other than the isolation material contained in the sample solution, depending on a difference in adsorption force. Thus, the substance to be adsorbed can be purified and isolated by collecting the fraction containing the substance to be adsorbed (isolation material).

It is known that a substance to be adsorbed, which is separated and purified using an adsorption apparatus as described above, elutes according to a Gaussian distribution in fractions which flows out of the column. Therefore, in order to purify and isolate the substance to be adsorbed (isolation material) with excellent accuracy, it is necessary to adjust the substance to be adsorbed to elute it in the fractions in a Gaussian distribution that exhibits a sharp peak. In particular, however, trailing skirt occurs in this peak, and this large tailing leads to a problem that the purification rate for the substance to be adsorbed cannot be sufficiently improved. The present inventors have found the presence of such problems.

### CITATION LIST

### Patent Literature

PTL 1: Patent Document 1: JP 2011-68539 A

### SUMMARY OF INVENTION

### Technical Problem

An object of the present invention is to provide a column for use in an adsorption apparatus capable of purifying and isolating a substance to be adsorbed, which is contained in a sample solution, at an excellent purification rate, and to an adsorption apparatus that includes the column.

### Solution to Problem

The object is achieved by the present invention described in (1) to (11) below.

(1) A column including:
a column main body that is tubular;
a first partition wall and a second partition wall that are disposed within the column main body and separated from each other along an axial direction of the column main body, the first partition wall and the second partition wall defining an adsorbent filling space therebetween;
a first lid defining a first space between the first lid and the first partition wall and having a first flow path communicating with the first space; and
a second lid defining a second space between the second lid and the second partition wall and having a second flow path communicating with the second space,
wherein
the first lid has a first lid surface facing the first space,
the second lid has a second lid surface facing the second space, and
when an angle formed by a first partition wall surface facing the first space of the first partition wall and the first lid surface is θ1 [°], and an angle formed by a second partition wall surface facing the second space of the second partition wall and the second lid surface is θ2 [°], at least one of Formula (1) and Formula (2) below is satisfied:

$$7.5 ° ≦ θ1 ≦ 20 ° \qquad ( 1 )$$

$$7.5 ° ≦ θ2 ≦ 20 ° . \qquad ( 2 )$$

As a result, it is possible to reduce trailing skirt in a peak, which is found in a peak indicating a content of the eluted substance to be adsorbed (isolation material), in a fraction that flows out of the adsorption apparatus. Therefore, the column can be used in an adsorption apparatus capable of purifying and isolating a substance to be adsorbed, which is contained in a sample solution, at an excellent purification rate.

(2) The column according to (1), wherein the first lid surface when the θ1 satisfies Formula (1) is an inclined surface that is inclined with respect to a transverse plane of the column main body.

The column of the present invention is suitably applied to a column having such a configuration.

(3) The column according to (2), wherein the first lid surface is a surface corresponding to a circumferential surface of a conical frustum having the first flow path as a center axis.

The column of the present invention is suitably applied to a column having such a configuration.

(4) The column according to (1), wherein the second lid surface when the θ2 satisfies Formula (2) is an inclined surface that is inclined with respect to a transverse plane of the column main body.

The column of the present invention is suitably applied to a column having such a configuration.

(5) The column according to (4), wherein the second lid surface is a surface corresponding to a circumferential surface of a conical frustum having the second flow path as a center axis.

The column of the present invention is suitably applied to a column having such a configuration.

(6) The column according to any one of (1) to (5), wherein the first partition wall and the second partition wall have liquid permeability.

The column of the present invention is suitably applied to a column having such a configuration.

(7) The column according to (6), wherein the first partition wall and the second partition wall are filter members.

The column of the present invention is suitably applied to a column having such a configuration.

(8) A column including:
a column main body that is tubular;
a first partition wall and a second partition wall that are disposed within the column main body and separated from each other along an axial direction of the column main body, the first partition wall and the second partition wall defining an adsorbent filling space therebetween;
a first lid defining a first space between the first lid and the first partition wall and having a first flow path communicating with the first space; and
a second lid defining a second space between the second lid and the second partition wall and having a second flow path communicating with the second space,
wherein
the first lid has a first lid surface facing the first space,
the second lid has a second lid surface facing the second space, and the first lid surface is inclined to approach a center in a length direction of the column main body from a center of the first lid surface toward an outer side thereof, and has an area of 100.40% or greater and 130.00% or less relative to a unit cross-sectional area of the column main body in a horizontal direction perpendicular to the length direction of the column main body, which occupies a region vertically below the first lid surface, or
the second lid surface is inclined to approach the center in the length direction of the column main body from a center of the second lid surface toward an outer side thereof, and has an area of 100.40% or greater and 130.00% or less relative to the unit cross-sectional area of the column main body in the horizontal direction perpendicular to the length direction of the column main body, which occupies a region vertically below the second lid surface.

As a result, it is possible to reduce trailing skirt in a peak, which is found in a peak indicating a content of the eluted substance to be adsorbed (isolation material), in a fraction that flows out of the adsorption apparatus. Therefore, the column can be used in an adsorption apparatus capable of purifying and isolating a substance to be adsorbed, which is contained in a sample solution, at an excellent purification rate.

(9) An adsorption apparatus including:
the column described in any one of (1) to (8); and
a powder of hydroxyapatite charged in the adsorbent filling space of the column.

The adsorption apparatus of the present invention is suitably applied to an adsorption apparatus including a powder of hydroxyapatite as an adsorbent, and, thus, can purify and isolate the substance to be adsorbed, which is contained in the sample solution, at an excellent purification rate.

(10) The adsorption apparatus according to (9), wherein the powder adsorbs a substance to be adsorbed when a sample solution containing the substance is supplied to the adsorbent filling space via the first flow path of the first lid in a state in which the first lid is located vertically above the second lid.

The adsorption apparatus of the present invention is suitably applied to an adsorption apparatus in which adsorption of a substance to be adsorbed is performed in the state described above, and thus can purify and isolate the substance to be adsorbed, which is contained in the sample solution, at an excellent purification rate.

(11) The adsorption apparatus according to (10), wherein the substance is purified by supplying a buffer solution to the adsorbent filling space, and the buffer solution is supplied to the adsorbent filling space at a rate of 40 cm/h or greater and 200 cm/h or less.

The adsorption apparatus of the present invention is suitably applied to an adsorption apparatus in which the buffer solution is supplied to the adsorbent filling space at the supply rate, and thus can purify and isolate the substance to be adsorbed, which is contained in the sample solution, at an excellent purification rate.

### Advantageous Effects of Invention

The present invention can provide a column for use in an adsorption apparatus capable of purifying and isolating a substance to be adsorbed, which is contained in a sample solution, at an excellent purification rate, and to an adsorption apparatus that includes the column.

### BRIEF DESCRIPTION OF DRAWINGS

FIG. 1 is a vertical cross-sectional view illustrating an example of an adsorption apparatus of the present invention.

FIG. 2 is a partially enlarged longitudinal cross-sectional view of a portion A illustrated in FIG. 1.

FIG. 3 is a partially enlarged longitudinal cross-sectional view of a portion B illustrated in FIG. 1.

FIG. 4 is a vertical cross-sectional view for describing a method of manufacturing an adsorption apparatus of Example 1.

FIG. 5 is a vertical cross-sectional view for describing the method of manufacturing the adsorption apparatus of Example 1.

FIG. 6 is a graph showing a relationship between an elution time (min) of an effluent and electrical conductivity (mS/cm) of the effluent in an adsorption apparatus of each of Examples 1 to 5 and Comparative Example 1.

FIG. 7 is an enlarged graph showing the relationship between the elution time (min) of the effluent and the electrical conductivity (mS/cm) of the effluent in the adsorption apparatus of each of Examples 1 to 5 and Comparative Example 1.

FIG. 8 is a graph showing the relationship between the elution time (min) of the effluent and the electrical conductivity (mS/cm) of the effluent in the adsorption apparatus of each of Example 1 and Comparative Example 1.

FIG. 9 is an enlarged graph showing the relationship between the elution time (min) of the effluent and the electrical conductivity (mS/cm) of the effluent in the adsorption apparatus of each of Example 1 and Comparative Example 1.

FIG. 10 is a graph showing the relationship between the elution time (min) of the effluent and the electrical conductivity (mS/cm) of the effluent in the adsorption apparatus of each of Example 2 and Comparative Example 1.

FIG. 11 is an enlarged graph showing the relationship between the elution time (min) of the effluent and the electrical conductivity (mS/cm) of the effluent in the adsorption apparatus of each of Example 2 and Comparative Example 1.

FIG. 12 is a graph showing the relationship between the elution time (min) of the effluent and the electrical conductivity (mS/cm) of the effluent in the adsorption apparatus of each of Example 3 and Comparative Example 1.

FIG. 13 is an enlarged graph showing the relationship between the elution time (min) of the effluent and the electrical conductivity (mS/cm) of the effluent in the adsorption apparatus of each of Example 3 and Comparative Example 1.

FIG. 14 is a graph showing the relationship between the elution time (min) of the effluent and the electrical conductivity (mS/cm) of the effluent in the adsorption apparatus of each of Example 4 and Comparative Example 1.

FIG. 15 is an enlarged graph showing the relationship between the elution time (min) of the effluent and the electrical conductivity (mS/cm) of the effluent in the adsorption apparatus of each of Example 4 and Comparative Example 1.

FIG. 16 is a graph showing the relationship between the elution time (min) of the effluent and the electrical conductivity (mS/cm) of the effluent in the adsorption apparatus of each of Example 5 and Comparative Example 1.

FIG. 17 is an enlarged graph showing the relationship between the elution time (min) of the effluent and the electrical conductivity (mS/cm) of the effluent in the adsorption apparatus of each of Example 5 and Comparative Example 1.

FIG. 18 is a graph showing the relationship between the elution time (min) of the effluent and the electrical conductivity (mS/cm) of the effluent in the adsorption apparatus of each of Comparative Example 2 and Comparative Example 1.

FIG. 19 is an enlarged graph showing the relationship between the elution time (min) of the effluent and the electrical conductivity (mS/cm) of the effluent in the adsorption apparatus of each of Comparative Example 2 and Comparative Example 1.

### DESCRIPTION OF EMBODIMENTS

A column and an adsorption apparatus according to the present invention will be described below in detail based on preferred embodiments illustrated in the ac-companying drawings.

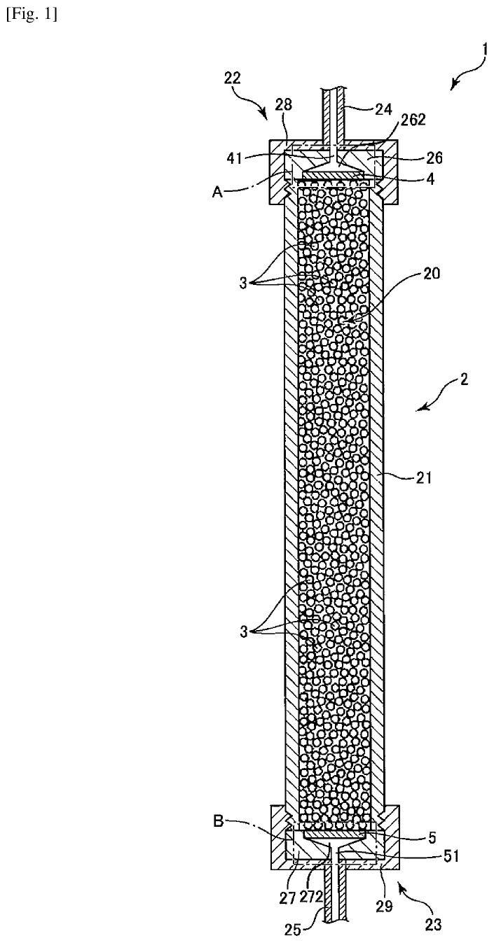

FIG. 1 is a vertical cross-sectional view illustrating an example of an adsorption apparatus of an embodiment of the present invention. Note that, in the following description, the upper side in FIG. 1 is referred to as “inflow side” and the lower side is referred to as “outflow side”.

Here, the “inflow side” refers to a side where, for example, a liquid such as a sample solution (a liquid containing a substance to be adsorbed) or an eluate (a liquid such as a buffer solution or water) is supplied into the adsorption apparatus, whereas the “outflow side” refers to a side opposite the inflow side, that is, a side where the liquid flows, as an effluent, out of the adsorption apparatus, when the substance to be adsorbed, as an isolation material such as a biopharmaceutical, i.e., a protein to be separated is purified and isolated.

An adsorption apparatus 1, as illustrated in FIG. 1, which purifies and isolates an isolation material such as a protein from a sample solution has a column 2, a particulate adsorbent (filler) 3.

The column 2 (column of an embodiment of the present invention) includes: a column main body 21; a cover portion 22 (first port) and a cover portion 23 (second port) attached to an inflow side end and an outflow side end, respectively, of the column main body 21; and filter member 4 and the filter member 5 disposed between the column main body 21 and the cover portions 22 and 23, respectively, to be interposed therebetween.

The column main body 21 is composed of a cylindrical member, for example. Examples of constituent materials of each component (each member), except the filter members 4 and 5, constituting the column 2 including the column main body 21 include various glass materials, various resin materials, various metal materials, and various ceramic materials.

In the column main body 21, the filter members 4 and 5 are disposed to be separated from each other along an axial direction of the column main body 21 in correspondence with an inflow side opening and an outflow side opening thereof, and thus the inflow side opening and the outflow side opening are closed by the filter members 4 and 5, respectively. In this state, the cover portions 22 and 23 are attached to the inflow side end and the outflow side end, respectively, of the column main body 21.

In the column 2 having such a configuration, the column main body 21 and the filter members 4 (first partition wall) and 5 (second partition wall) define an adsorbent filling space 20 between the filter member 4 and the filter member 5 within the column main body 21.

Additionally, the column main body 21 and the cover portions 22 and 23 ensure that the adsorbent filling space 20 has liquid tightness. The adsorbent 3 is charged into at least a part (substantially a full capacity, in the present embodiment) of the adsorbent filling space 20.

In a preferred embodiment of the present invention, an inner diameter of the adsorbent filling space 20 (column inner diameter) is set appropriately in accordance with a volume of a sample solution and the like, and is not particularly limited, but is preferably approximately 10.0 mm or greater and 100.0 mm or less, and more preferably approximately 20.0 mm or greater and 70.0 mm or less. In addition, a length of the adsorbent filling space 20 (column length) is, for example, preferably approximately 10.0 mm or greater and 300.0 mm or less, and more preferably approximately 20.0 mm or greater and 200.0 mm or less.

By setting the dimensions of the adsorbent filling space 20 to the values as described above and setting the dimensions of the adsorbent 3 described later to values as will be described below, it is possible to selectively isolate (purify) the target material to isolate from the sample solution, that is, to reliably separate a substance to be adsorbed (isolation material) such as a protein and contamination substances other than the isolation material contained in the sample solution from each other. Furthermore, the present invention is preferably applied to the adsorption apparatus 1 provided with the column 2 having the dimensions of the adsorbent filling space 20 set as described above. That is, at least one of Formula (1) and Formula (2) below is satisfied for the adsorption apparatus 1 having such a configuration, and thus it is possible to reliably improve the purification rate for the substance to be adsorbed, which is separated and purified, in the fractions collected by the adsorption apparatus 1.

Note that the isolation material to be isolated (purified) using the adsorbent 3 is not limited to proteins such as albumin, acidic proteins such as antibodies, and basic proteins, and that examples thereof include acidic amino acids; negatively charged substances such as DNA, RNA, and negatively charged liposomes; and positively charged substances such as basic amino acids, positively charged cholesterol, and positively charged liposomes. That is, various substances including bio-based pharmaceuticals such as antibodies and vaccines can be purified and isolated, as substances to be adsorbed, using the adsorbent 3.

Further, the cover portions 22 and 23 are attached to the column main body 21 to ensure liquid tightness therebetween.

The cover portion 22 (first port) and the cover portion 23 (second port) include: a cap 28 and a cap 29; an inlet pipe 24 and an outlet pipe 25; and a lid 26 and a lid 27, respectively.

The caps 28 and 29 are attached by screwing to the inflow side end (one end) and the outflow side end (the other end) of the column main body 21, with the inflow side end of the column main body 21 being located vertically above and the outflow side end being located vertically below. Each of the caps 28 and 29 and the column main body 21 ensure liquid tightness therebetween.

Also, the inlet pipe 24 and the outlet pipe 25 are composed of a tube body through which the liquid flows, and are adhered (fixed) liquid-tightly to substantially centers of the caps 28 and 29, respectively.

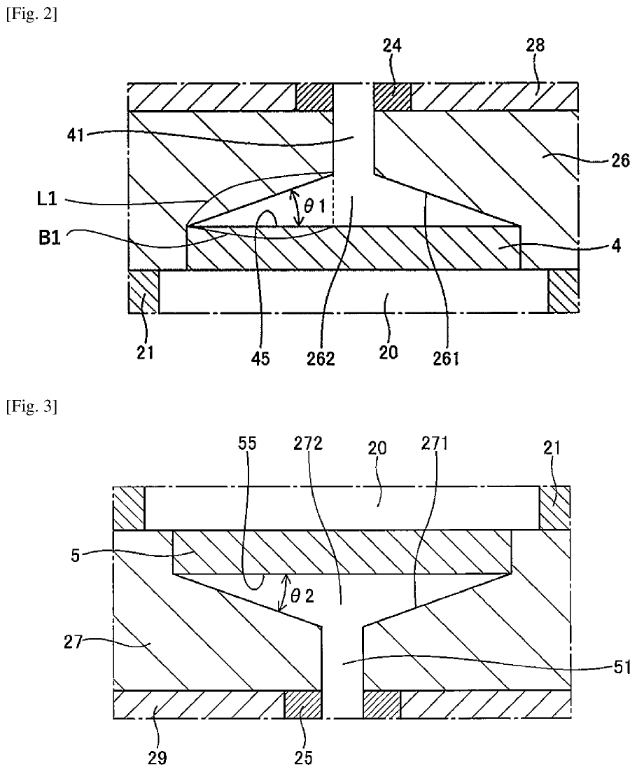

Furthermore, as illustrated in FIGS. 2 and 3, the lids 26 and 27 include a flow path 41 (first flow path) and a flow path 51 (second flow path) that are disposed between the filter members 4 and 5 and the caps 28 and 29, respectively, and communicate with the inlet pipe 24 and the outlet pipe 25, respectively; and a lid surface 261 (first lid surface) and a lid surface 271 (second lid surface) facing the filter member 4 and the filter member 5, respectively.

In such lids 26 and 27, a space 262 (first space) is defined by the lid surface 261 and the filter member 4, and a space 272 (second space) is defined by the lid surface 271 and the filter member 5.

The lid surfaces 261 and 271 are surfaces corresponding to circumferential surfaces of conical frustums with the flow paths 41 and 51 as central axes, respectively, so that the lid surfaces 261 and 271 constitute inclined surfaces that are inclined with respect to a transverse plane of the column main body 21, i.e., flat surfaces 45 and 55 facing the lid surfaces 261 and 271 of the filter members 4 and 5, respectively.

The lid surfaces 261 and 271 of the lids 26 and 27 having such a configuration and the flat surfaces 45 and 55 of the filter members 4 and 5 define the spaces 262 and 272, respectively, that form a conical frustum-like shape.

An inlet path defined by the inlet pipe 24 and the flow path 41 is in communication with the space 262, and the liquid is supplied through the inlet path, and then supplied from the space 262 to the adsorbent 3 via the filter member 4. In other words, the liquid is supplied from the space 262 side to the adsorbent 3 via the filter member 4 in a state in which the flow path through which the liquid flows is in a funnel shape having a diameter expanding from the inlet pipe 24 toward the space 262.

The liquid supplied to the adsorbent 3 passes between the adsorbents 3 (gap), is supplied to the space 272 via the filter member 5, and then flows out of the column 2 from the space 272 through an outlet path defined by the flow path 51 communicating with the space 272 and the outlet pipe 25. In other words, the liquid is supplied from the adsorbent 3 to the space 272 side via the filter member 5 in a state in which the flow path through which the liquid flows is in a funnel shape having a diameter reducing from the space 272 toward the outlet pipe 25. At this time, when the sample solution is supplied as the liquid to the adsorbent 3, the substance to be adsorbed (isolation material) and the contamination substances other than the substance to be adsorbed (isolation material), contained in the sample solution (sample), are separated from each other based on a difference in adsorbability to the adsorbent 3 and a difference in affinity for the eluate.

In other words, in a state in which the cover portion 22 is located vertically above the cover portion 23, the adsorption apparatus 1 supplies the liquid to the adsorbent filling space 20 via the inlet pipe 24, adsorbs the substance to be adsorbed by the adsorbent 3 charged in the adsorbent filling space 20, and uses the adsorption of this substance to be adsorbed to purify and isolate the substance to be adsorbed (isolation material).

The filter member 4 (first partition wall) and the filter member 5 (second partition wall) each have liquid permeability (liquid passing property) that allows uniform passage of the liquid in the thickness direction thereof between the space 262 and the space 272, respectively, and the adsorbent filling space 20. In other words, they have a function of supplying the liquid from the space 262 to the adsorbent filling space 20 (adsorbent 3), and further flowing the liquid out of the adsorbent filling space 20 (adsorbent 3) to the space 272. With such a function, they have a function of preventing the adsorbent 3 from flowing out of the adsorbent filling space 20, that is, a function of retaining the adsorbent 3 within the adsorbent filling space 20.

These filter members 4 and 5 are each composed of, for example, a polypropylene mesh, a sintered filter of polyethylene particles, a stainless mesh filter, or a sintered filter of stainless particles.

In the adsorption apparatus 1, the adsorbent 3 includes a powder formed from a collection of fine particles having a non-constant particle size, and has adsorption capability to the isolation material (substance to be adsorbed) contained in the sample solution (sample), and is preferably composed of a green powder formed from particles containing secondary particles of hydroxyapatite or a sintered powder thereof. Note that, in the present specification, the green powder and sintered powder of hydroxyapatite are collectively referred to as “powder of hydroxyapatite”. Therefore, a description is given below as an example of a case in which the powder of hydroxyapatite is charged in the adsorbent filling space 20 of the column main body 21 as the adsorbent 3.

The powder (green powder) of hydroxyapatite contains secondary particles thereof, further primary particles and multi-order particles, and is composed mainly of secondary particles thereof.

In addition, the secondary particles of hydroxyapatite (Ca10(PO4)6(OH)2) are composed mainly of hydroxyapatite, which are obtained by drying a slurry containing primary particles thereof and aggregates thereof and granulating them. The hydroxyapatite has a chemically stable apatite structure, and a powder containing secondary particles of the hydroxyapatite can be suitably used, in particular, for the adsorbent 3 included in the adsorption apparatus 1. The hydroxyapatite is intended to have a Ca/P ratio of approximately 1.64 or greater and 1.70 or less.

Furthermore, the secondary particles are not particularly limited, but preferably have a bulk density of 0.65 g/mL or greater and a specific surface area of 70 m2/g or greater. The secondary particles can be more preferably used for the adsorbent 3 included in the adsorption apparatus 1.

When the sample solution is supplied to the adsorbent 3 having such a configuration, the substance to be adsorbed (isolation material) contained in the sample solution specifically adsorbs by its inherent adsorption (carrying) force, and is purified and isolated from contamination substances other than the substance to be adsorbed (isolation material) contained in the sample solution in accordance with a difference in adsorption force.

As described above, the bulk density of the secondary particles of hydroxyapatite is preferably set to 0.65 g/mL or greater, but is more preferably approximately 0.70 g/mL or greater and 0.95 g/mL or less. Secondary particles having a bulk density within such a range are considered to have a high weight and less voids in the particles, and can be said to be particles having a high filling density, and therefore exhibit high strength. Therefore, when a green powder containing the secondary particles or a sintered powder thereof is applied as the adsorbent 3, the lifetime can be extended.

Furthermore, as described above, in the present embodiment, the specific surface area is preferably set to 70 m2/g or greater, but is more preferably approximately 75 m²/g or greater and 100 m²/g or less. When the green powder containing secondary particles having such a high specific surface area or the sintered powder thereof is applied as the adsorbent 3, the opportunity for the substance to be adsorbed to contact the adsorbent 3 increases, and the interaction between the substance to be adsorbed and the adsorbent 3 is improved. Therefore, the adsorbent 3 exhibits excellent adsorption capability to the substance to be adsorbed.

Furthermore, a form (shape) of the secondary particles is preferably particulate (granular), as illustrated in FIG. 1, but a sphericity thereof is more preferably approximately 0.95 or greater and 1.00 or less, and further preferably 0.97 or greater and 1.00 or less. In this manner, when a green powder containing secondary particles having high sphericity or a sintered powder thereof is applied as the adsorbent 3, it is possible to improve a filling rate of the adsorbent 3 into the adsorbent filling space 20.

When a repose angle of such secondary particles is preferably 270 or less, and more preferably approximately 220 or greater and 250 or less, when the secondary particles are classified into a size of 40±4 μm. Secondary particles having such a low repose angle are highly fluid, and can improve the operability (filling efficiency) when a green powder containing the secondary particles or a sintered powder thereof is charged as the adsorbent 3 in the adsorbent filling space 20.

In addition, when the sintered powder is obtained by firing the green powder containing secondary particles at 700° C., an average pore size of pores formed in a surface thereof is preferably 0.07 μm or less, and more preferably approximately 0.04 μm or greater and 0.06 μm or less. Furthermore, when it is obtained by firing the green powder containing secondary particles at 400° C., the average pore size of pores is preferably 0.05 μm or less, and more preferably approximately 0.02 μm or greater and 0.04 μm or less. By setting the average pore size of pores within such a range, the specific surface area of the sintered powder can be reliably increased.

Note that, in the present embodiment, the adsorbents 3 that are charged in the adsorbent filling space 20 of the adsorption apparatus 1 of an embodiment of the present invention are a powder of hydroxyapatite, but the adsorbents 3 contain a powder formed from a collection of fine particles having a non-constant particle size. In a preferred embodiment of the present invention, the collection of fine particles preferably has a predetermined mode particle size (mode diameter) and has a peak particle size distribution curve centered on a value of the mode particle size. In another preferred embodiment of the present invention, the collection of fine particles preferably has a particle size distributed above and below the value of the mode particle size such that an appearance frequency is lower away from the value of the mode particle size.

In addition to the powder of hydroxyapatite shown in the present embodiment, the powder constituting the adsorbents 3 charged in the adsorbent filling space 20 of the adsorption apparatus 1 according to an embodiment of the present invention may be a powder of an inorganic compound such as silica, fluoroapatite, calcium pyrophosphate, magnesium pyrophosphate, alumina, or zirconia, may be a powder of an organic compound such as a polymer bead, or may be a polymer such as sepharose or agarose, or a mixture thereof. The effect of the present invention is more effective when a product containing a powder formed from a collection of fine particles having a non-constant particle size is used as the adsorbent 3.

The powder of hydroxyapatite may be a commercially available product. The powder of hydroxyapatite may be, for example, CHT (trade name in the U.S.) Type I, CHT (trade name in the U.S.) Type II, or CHT (trade name in the U.S.) XT, or MPC or CFT, available from Bio-Rad Laboratories.

When manufacturing the powder of hydroxyapatite, the powder of hydroxyapatite can be manufactured according to the methods described in, for example, JP 7-88205 B and JP 5724050 B2. Specifically, to manufacture powder of hydroxyapatite, a manufacture method can be performed which includes a step [S1A] of reacting a first liquid containing a calcium source such as calcium hydroxide and a second liquid containing a phosphoric source such as phosphoric acid while stirring to obtain a slurry containing primary particles of hydroxyapatite and aggregates thereof; a step [S2A] of physically pulverizing the aggregates contained in the slurry and dispersing the pulverized aggregates in the slurry; and a step [S3A] of drying the slurry to granulate the pulverized aggregates, thereby obtaining a powder composed of particles containing mainly secondary particles of hydroxyapatite.

The powder constituting the adsorbents 3 charged in the adsorbent filling space 20 of the adsorption apparatus of an embodiment of the present invention may be a green powder or a sintered powder. Also, the powder constituting the adsorbents 3 charged in the adsorbent filling space 20 of the adsorption apparatus 1 of an embodiment of the present invention may be classified or may not be classified. When the powder is not classified, the powder will have a wider particle size distribution curve, and, therefore, the effect according to the present invention can be more significantly exhibited.

When the powder constituting the adsorbents 3 charged in the adsorbent filling space 20 of the adsorption apparatus 1 of an embodiment of the present invention is classified, it may have an average particle size and a particle size distribution curve such as a particle size 20±4 μm, a particle size 40±4 μm, a particle size 60±4 μm, and a particle size 80±4 μm.

Next, a separation method of purifying and isolating a substance to be adsorbed using an adsorption apparatus 1 will be described.

In the present embodiment, the method of separating a substance to be adsorbed includes a step [SiB] of contacting a sample solution with an adsorbent 3; and a step [S2B] of fractionating an effluent from a column 2 by a predetermined amount.

These steps will be described sequentially below.

{S1B: Step of Contacting Sample Solution with Adsorbent 3}

In this step, a sample solution (liquid) containing a substance to be adsorbed as an isolation material to be purified is supplied to the adsorbent 3 via an inlet pipe 24, a flow path 41 of a lid 26, a space 262, and a filter member 4, i.e., is passed through the adsorbent filling space 20 of the column 2 (adsorption apparatus 1), so that the sample solution is contacted with the adsorbent 3 charged in the adsorbent filling space 20.

As a result, among substances to be adsorbed (isolation materials) having high adsorption capability to the adsorbent 3 and contamination substances other than the substances to be adsorbed (isolation materials), those having a relatively high adsorption capability to the adsorbent 3 adsorb onto the adsorbent 3, and thus are retained in the adsorbent filling space 20 of the column 2. Then, contamination substances having low adsorption capability to the adsorbent 3 flow out of the adsorbent filling space 20 of the column 2 via a filter member 5, a space 272, a flow path 51 of a lid 27, and an outlet pipe 25.

{S2B: Step of Fractionating Effluent from Column 2 by Predetermined Amount}

In this step, a buffer solution is supplied from the inlet pipe 24 into the adsorbent filling space 20 of the column 2 as an eluate (liquid) for eluting the substance to be adsorbed, and the effluent flowing out through the outlet pipe 25 from the adsorbent filling space 20 of the column 2 is fractionated (collected) by a predetermined amount.

As a result, the substance to be adsorbed and the contamination substances, which are adsorbed on the adsorbent 3, are collected (separated) in a state in which each substance is eluted in each fraction as the effluent in accordance with a difference in adsorption force to the adsorbent 3 between the substances. Thus, among the fractions collected, the fractions containing the substance to be adsorbed (isolation material) are collected so that the substance to be adsorbed (isolation material) can be purified and isolated.

The buffer solution is not particularly limited, but a phosphate-based buffer solution is preferably used, for example. Examples of the phosphate-based buffer solution include sodium phosphate, potassium phosphate, and lithium phosphate.

The pH of the buffer solution is not particularly limited, but is preferably approximately 6 or greater and 8 or less, and more preferably approximately 6.5 or greater and 7.5 or less. As a result, degeneration and deterioration of the substance to be adsorbed, which is separated, can be prevented. In addition, since the degeneration (such as dissolution) of the adsorbent 3 can be suitably prevented, changes in separation capability of the adsorption apparatus 1 can be securely suppressed or prevented.

The temperature of the buffer solution is not particularly limited, but is preferably approximately 30° C. or higher and 50° C. or lower, and more preferably approximately 35° C. or higher and 45° C. or lower. As a result, degeneration and deterioration of the substance to be adsorbed, which is separated, can be securely suppressed or prevented.

Therefore, a buffer solution having such a pH range and such a temperature range can be used to improve the collection rate of the target substance to be adsorbed.

In addition, the supply rate of the buffer solution as the eluate to the adsorbent filling space 20 of the column 2 is not particularly limited, but is, for example, set to preferably approximately 40 cm/h or greater and 200 cm/h or less, and more preferably approximately 80 cm/h or greater and 150 cm/h or less. By setting the supply rate within the range described above, the target substance to be adsorbed can be efficiently collected. The present invention is also preferably applied when the supply rate is set within the range. That is, the effect obtained by satisfying at least one of Formula (1) and Formula (2), which will be described below, can be exhibited more significantly.

The substance to be adsorbed is purified and isolated by collecting the fraction containing the substance to be adsorbed (isolation material) in the operation as described above. It is known that the substance to be adsorbed elutes according to a Gaussian distribution, as described above, in the fractions as the effluent flowing out through the outlet pipe 25. Therefore, in order to purify and isolate the substance to be adsorbed with excellent accuracy, it is necessary to adjust the substance to be adsorbed to elute it in the collected fractions in a Gaussian distribution that exhibits a sharp peak. In particular, however, trailing skirt occurs in this peak, and this large tailing leads to a problem that the purification rate for the substance to be adsorbed cannot be sufficiently improved.

With regard to the problem, as a result of diligent research, the present inventors have found that the occurrence of tailing in the peak is associated with non-uniformity in passage rate of the eluate and effluent passing through the filter members 4 and 5 in the thickness direction, i.e., a difference between the passage rate at a center portion side of the filter members 4 and 5 and the passage rate at an edge side thereof, when the effluent is supplied from the space 262 to the filter member 4, and, in addition, when the effluent is supplied from the filter member 5 to the space 272, in the step [S2B].

As a result of further investigation by the present inventors, it have been found that angles θ1 and 02 formed by the lid surfaces 261 and 271 of the lids 26 and 27 and the flat surfaces 45 and 55 (first partition wall surface and second partition wall surface) of the filter members 4 and 5 in the spaces 262 and 272, respectively, are closely related to the occurrence of the difference in passage rate described above. By setting the angles θ1 and 02 such that at least one of Formula (1) and Formula (2) below is satisfied, it is possible to securely suppress the occurrence of the difference in passage rate, and to set the passage rate substantially uniformly from the center portion side of the filter members 4 and 5 to the edge side thereof. Therefore, the inventors have discovered that the size of tailing in the peak can be reliably reduced, that is, the substance to be adsorbed can be purified and isolated, at an excellent purification rate, using the adsorption apparatus 1, and thus have completed the present invention.

$$7.5 ° ≦ θ1 ≦ 20 ° , \qquad ( 1 )$$

$$7.5 ° ≦ θ2 ≦ 20 ° \qquad ( 2 )$$

Here, when the angle θ1 formed by the lid surface 261 of the lid 26 and the flat surface 45 of the filter member 4 satisfies 7.5°≤θ1≤20°, the angle θ1 has only to satisfy 7.5°≤θ1≤20°, but preferably satisfies 7.5°≤θ1≤13.5° and more preferably satisfies 8.0°≤θ1≤12.0°.

Further, when the angle θ2 formed by the lid surface 271 of the lid 27 and the flat surface 55 of the filter member 5 satisfies 7.5°≤θ2≤20°, the angle θ2 has only to satisfy 7.5°≤θ2≤20°, but preferably satisfies 7.5°≤θ2≤13.5° and more preferably satisfies 8.0°≤θ2≤12.0°.

The angle θ1 and the angle θ2 each satisfy the relationship described above, so that the substance to be adsorbed can be purified and isolated at a better purification rate. Further, when the angle θ1 and the angle θ2 are each the lower limit value or greater, the space in which the liquid moves can be sufficiently ensured by ensuring a volume equal to or greater than a predetermined value in the spaces 262 and 272, and the passage rate on the center portion side of the filter members 4 and 5 can be set to be close to that on the edge side thereof. Further, when the angle θ1 and the angle θ2 are each the upper limit value or less, the volumes of the spaces 262 and 272 are within appropriate ranges, and, due to convection occurring when the liquid moves within the spaces 262 and 272, it is possible to prevent a difference between the passage rate on the center portion side of the filter members 4 and 5 and the passage rate on the edge side thereof.

Furthermore, at least one of Formula (1) and Formula (2) for the angle θ1 and the angle θ2, respectively, has only to be satisfied. If either one of Formulas (1) and (2) is satisfied, the above Formula (1) is preferably satisfied. More preferably, both Formulas (1) and (2) are satisfied. As a result, the substance to be adsorbed can be purified and isolated at a better purification rate. Furthermore, the angle θ1 and the angle θ2 may be the same or different.

In the flat surface 45, a ratio of an area L1 of the lid surface 261 to an area B1 of a region of the flat surface 45 that occupies a region vertically below the lid surface 261 is preferably 100.40% or greater. The ratio is preferably 130.00% or less. Furthermore, as the lower limit value, the ratio is more preferably 100.85% or greater. The ratio is more preferably 101.00% or greater, further preferably 101.25% or greater, and even further preferably 101.50% or greater. Furthermore, as the upper limit value, the ratio is more preferably 125.00% or less. The ratio is more preferably 120.00% or less, further preferably 115.00% or less, and even further preferably 110.00% or less.

The above area ratio is an area of the lid surface 261 relative to the unit cross-sectional area of the column 2 in a horizontal direction perpendicular to a length direction of the column 2. For example, in FIG. 2, in the case of θ1=0°, the unit cross-sectional area of the column 2 in the horizontal direction and the area of the lid surface 261 are the same, and thus the ratio is 100%. For θ1=45°, the ratio is root 2/1×100=141.42%. In addition to the area ratio described above, the lid surface 261 preferably has a shape of extending downward from the center toward the periphery. As a result, even when the lid surface 261 is not planar, it can be expected that the same function/effect as that obtained when the lid surface 261 is planar and has a preferred 01 angle can be exhibited. The same applies to the relationship between the lid surface 271 and the flat surface 55.

The column and the adsorption apparatus according to an embodiment of the present invention have been described above, but the present invention is not limited thereto.

For example, in the column and the adsorption apparatus according to an embodiment of the present invention, each of the configurations can be substituted by any configuration that can perform a similar function, or can be added with any configuration.

Further, in the above-described embodiment, a case has been described in which the column main body included in the column is cylindrical. However, the column main body may be tubular, and may have a polygonal tubular shape such as a hexagonal or heptagonal shape.

### EXAMPLE

Next, specific examples of the present invention will be described.

Note that the present invention is not limited to the description of these examples.

1. Manufacture of adsorption apparatus

### Example 1

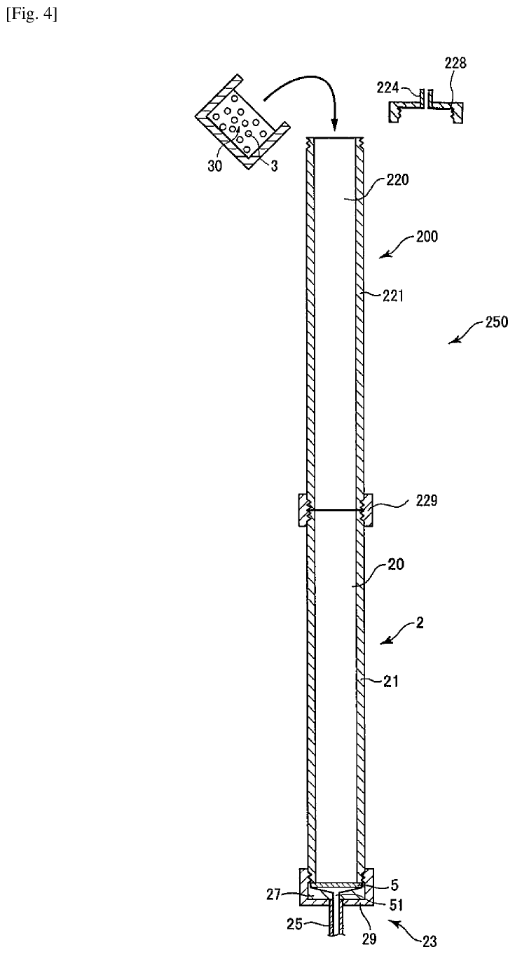

First, as a column 2, a column including: a column main body 21 having a column inner diameter φ of 50 mm×a column length of 200 mm; cover portions 22 and 23 having lids 26 and 27 having lid surfaces 261 and 271, respectively, such that θ1 and θ2=10°, and filter members 4 and 5 having a diameter φ of 45 mm×a thickness of 5 mm was prepared. Further, an extension column 200 including a column passage section 221 having a column inner diameter φ of 50 mm×a column length of 230 mm was prepared. A column connection body 250 was obtained by attaching a connection section 229 of the extension column 200 to an inflow side end of the column main body 21 of the column 2 by screwing (see FIG. 4).

A slurry 30 was prepared by weighing 248 g of a sintered powder of hydroxyapatite (CHT 40 m Type I, available from Bio-Rad Laboratories) as an adsorbent 3, and dispersing while stirring the adsorbent 3 in 737 mL of a 0.2 mM sodium phosphate buffer solution at 25° C.

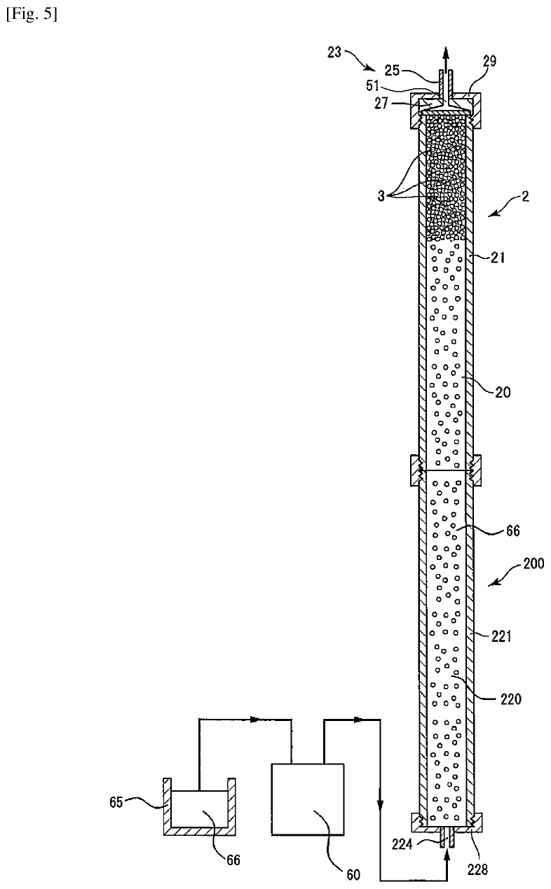

The column connection body 250 was then disposed such that column 2 was located vertically below, and that the extension column 200 was located vertically above, as shown in FIG. 4. Thereafter, the slurry 30 was supplied to an adsorbent passage space 220 included in the column passage section 221 from an opening that opened at an upper end of the column passage section 221 included in the extension column 200, so that the slurry 30 was charged in the adsorbent passage space 220. A cap 228 was then attached to the upper end of the column passage section 221 by screwing. Then, by inverting the column connection body 250 a plurality of times in the vertical direction while stirring, the filler precipitated by gravity was suspended. At the same time when the column connection body 250 was maintained in a posture in which the column 2 was located vertically above and the extension column 200 was located vertically below, the supply of water as a filling solution 66 contained in a container 65 to the adsorbent passage space 220 of the column passage section 221 via an inlet pipe 224 of the cap 228 was started using a pump 60 (see FIG. 5). At this time, a flow rate of water to the adsorbent passage space 220 of the column passage section 221 using the pump 60 was set to 160 mL/min.

Next, the supply of water to the adsorbent passage space 220 of the column passage section 221 using the pump 60 was continued until the adsorbent 3 rose sequentially in the adsorbent passage space 220 included in the column passage section 221 and the adsorbent filling space 20 included in the column main body 21, so that the adsorbent 3 was substantially fully charged in the adsorbent filling space 20 included in the column main body 21. The column was then returned to its original state, and the adsorbent was fully charged therein.

The operation of the pump 60 was then stopped, thereby terminating the supply of water to the adsorbent passage space 220 of the column passage section 221. Then, the extension column 200 was disengaged from the column 2 due to disengagement, from the column main body 21, of the connection section 229, which was attached, by screwing, to the inflow side end of the column main body 21 of the column 2. Then, the cover portion 22 was attached to the inflow side end of the column main body 21 in a state in which the filter member 4 was interposed on the inflow side end of the column main body 21, so that an adsorption apparatus 1 of Example 1 was obtained.

### Examples 2 to 5 and Comparative Examples 1 and 2

Adsorption apparatuses 1 of Examples 2 to 5 and Comparative Example 1 were obtained in the same manner as in Example 1, except that there were prepared: cover portions 22 and 23 including lids 26 and 27 having lid surfaces 261 and 271, respectively, such that θ1, 02=7.5° (Example 2); θ1, 02=13.5° (Example 3); θ1, θ2=20° (Example 4); θ1, θ2=5°, 100 (Example 5); θ1, θ2=5° (Comparative Example 1); and θ1, θ2=40° (Comparative Example 2).

### 2. Purification and Isolation of Substance to be Adsorbed by Adsorption Apparatus

First, a sample solution was prepared by dissolving sodium chloride in ion exchanged water to achieve a concentration of 1 M.

The column was then equilibrated with a 0.1 M NaCl solution at a rate of 100 cm/h for the adsorption apparatuses 1 of Examples 2 to 5 and Comparative Example 1. Thereafter, 40 mL of the sample solution was supplied (applied) into the adsorption apparatus 1. Thereafter, the electrical conductivity of the effluent exiting the adsorption apparatus 1 was measured while 500 mL of the 0.1 M NaCl solution was flowed into the adsorption apparatus 1 at the same rate.

In addition, the electrical conductivity (mS/cm) of the effluent flowing out of the column 2 was measured, over time, using an electrical conductivity meter associated with a liquid chromatography instrument (“BioLogic DuoFlow 40”, available from Bio-Rad Laboratories).

Furthermore, for the adsorption apparatus 1 of Comparative Example 2, the electrical conductivity of the effluent was measured in the same manner as for the adsorption apparatuses 1 of Examples 2 to 5 and Comparative Example 1, except that the rate at which the 0.1 M NaCl solution was flowed into the adsorption apparatus 1 was 50 cm/h.

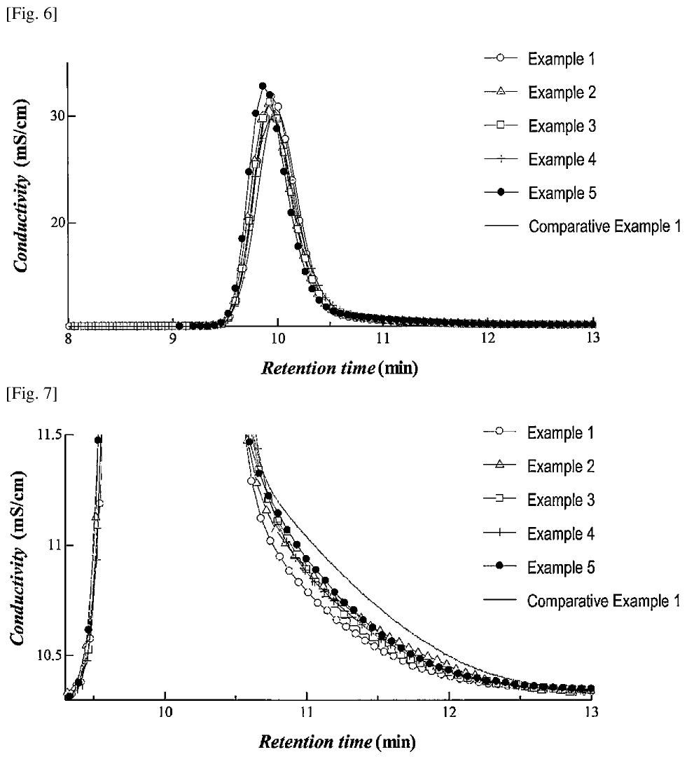

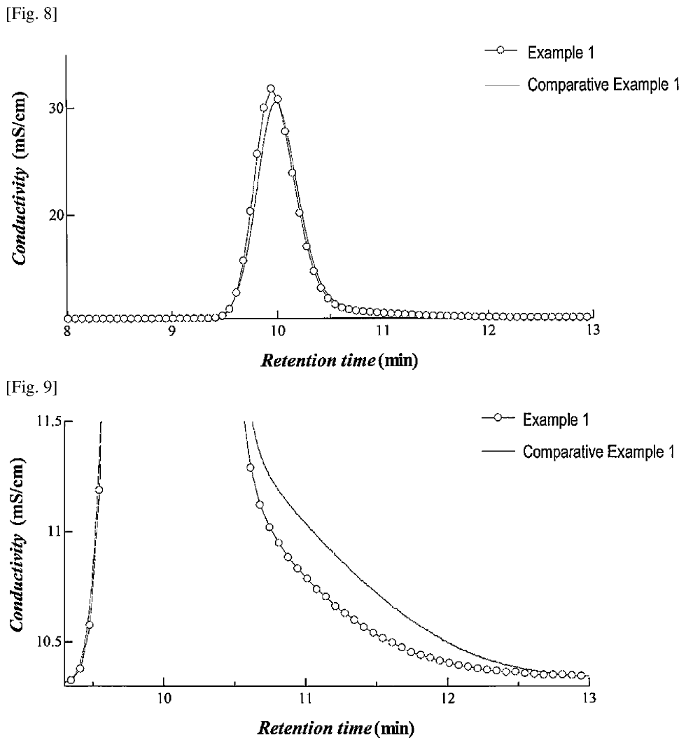

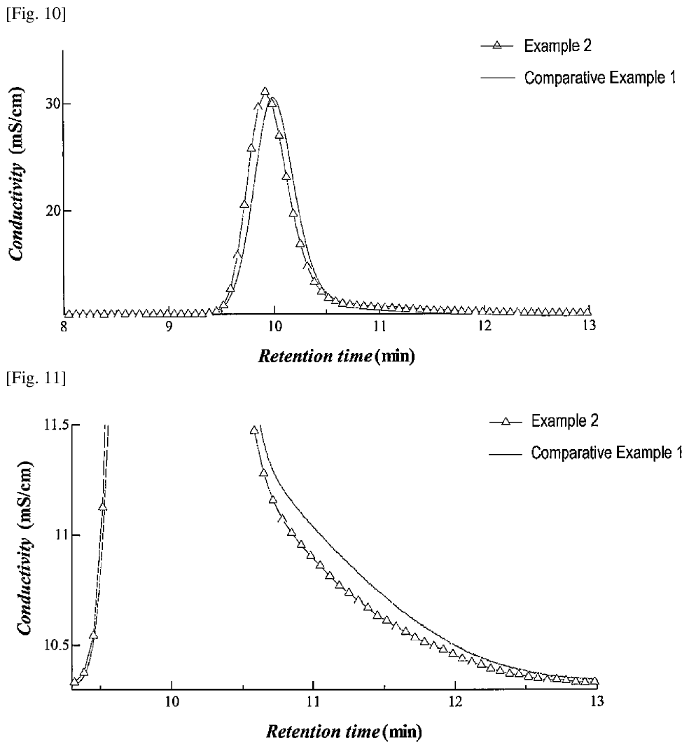

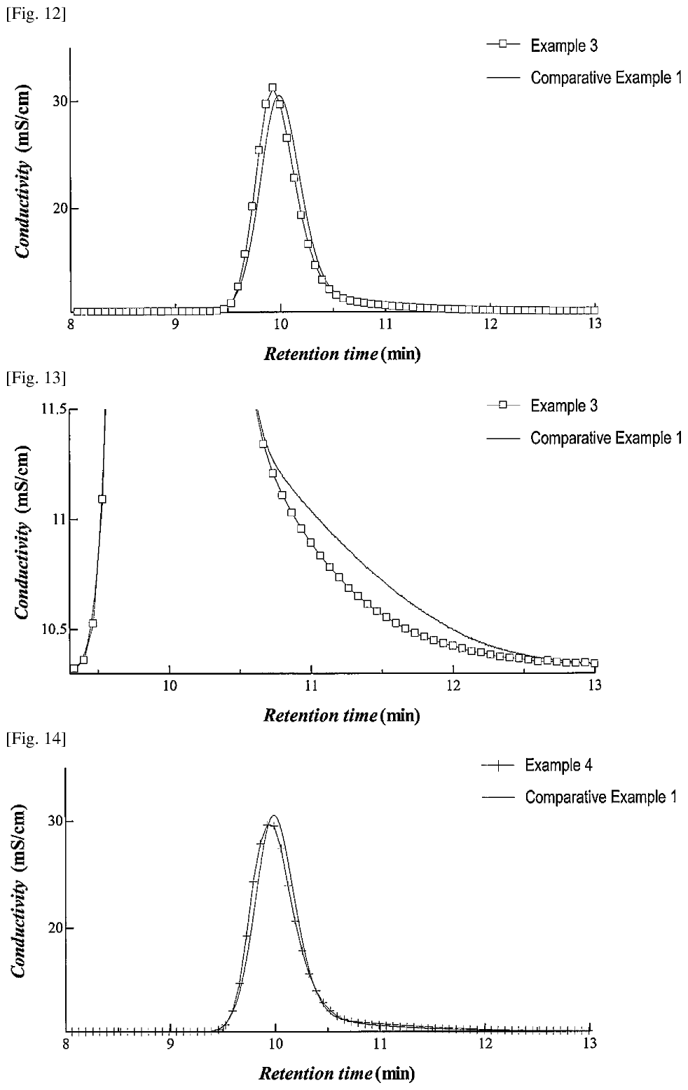

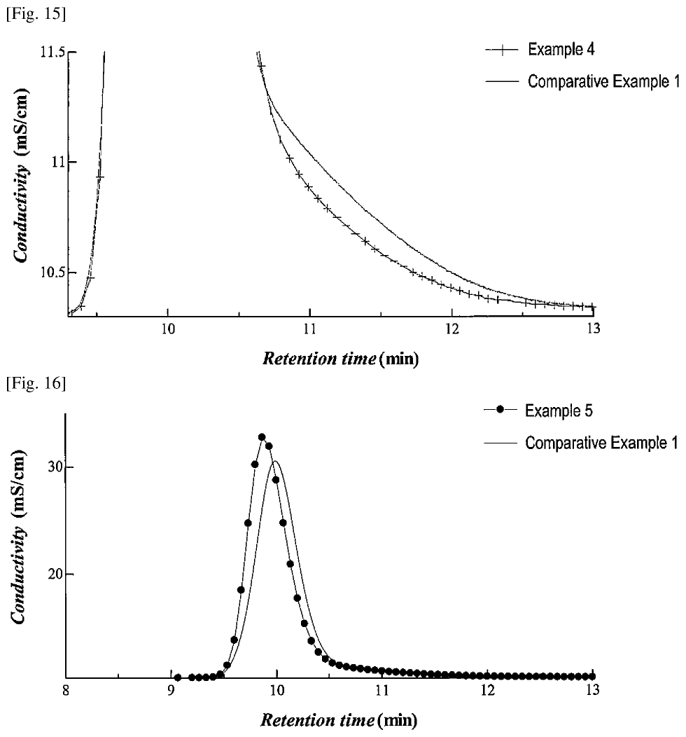

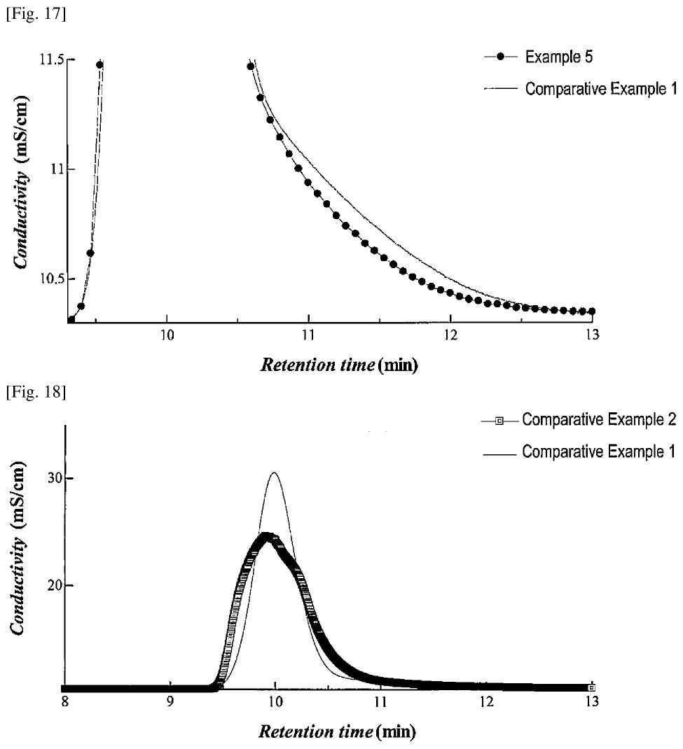

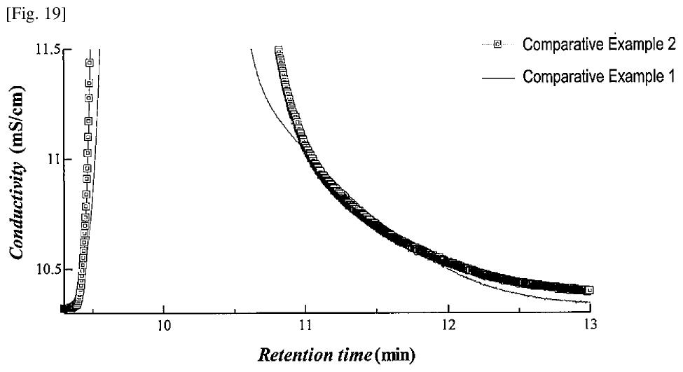

A graph showing a relationship between an elution time (min) of the effluent and electrical conductivity (mS/cm) of the effluent, obtained by measuring the electrical conductivity, is illustrated in each of FIGS. 6 to 19 for the adsorption apparatus 1 of each of the examples and the comparative examples. Note that, FIGS. 6 and 7, the relationships in Examples 1 to 5 and Comparative Example 1 are shown graphically; in FIGS. 8 to 17, the relationships in one of Examples 1 to 5 and Comparative Example 1 are shown graphically; and, in FIG. 18 and FIG. 19, the relationships in Comparative Example 2 and Comparative Example 1 are shown graphically.

As is clear from FIGS. 6 to 17, in each example, the result showed that the occurrence of tailing was adequately suppressed in the peak indicating the content of NaCl as the sample in the effluent (fraction) flowing out of the column 2, as compared with each comparative examples.

In other words, the adsorption apparatus of each example exhibited a result that the substance to be adsorbed could be purified and isolated at a higher purification rate, as compared with the adsorption apparatus of each comparative example.

### REFERENCE SIGNS LIST

1 Adsorption apparatus
2 Column
3 Adsorbent
4 Filter member
5 Filter member
20 Adsorbent filling space
21 Column main body
22 Cover portion
23 Cover portion
24 Inlet pipe
25 Outlet pipe
26 Lid
27 Lid
28 Cap
29 Cap
30 slurry
41 Flow path
51 Flow path
45 Flat surface
55 Flat surface
60 Pump
65 Container
66 Filling solution
200 Extension column
220 Adsorbent passage space
221 Column passage section
224 Inlet pipe
228 Cap
229 Connection section
250 Column connection body
261 Lid surface
271 Lid surface
262 Space
272 Space
θ1 Angle
θ2 Angle

1. A column comprising:
a column main body that is tubular;
a first partition wall and a second partition wall that are disposed within the column main body and separated from each other along an axial direction of the column main body, the first partition wall and the second partition wall defining an adsorbent filling space therebetween;
a first lid defining a first space between the first lid and the first partition wall and having a first flow path communicating with the first space; and
a second lid defining a second space between the second lid and the second partition wall and having a second flow path communicating with the second space,
wherein
the first lid has a first lid surface facing the first space,
the second lid has a second lid surface facing the second space, and
when an angle formed by a first partition wall surface facing the first space of the first partition wall and the first lid surface is θ1 [°], and an angle formed by a second partition wall surface facing the second space of the second partition wall and the second lid surface is θ2 [°], at least one of Formula (1) and Formula (2) is satisfied:
$$7.5 ° \leq θ1 \leq 20 ° \qquad ( 1 )$$
$$7.5 ° \leq θ2 \leq 20 ° . \qquad ( 2 )$$

2. The column according to claim 1, wherein the first lid surface when the θ1 satisfies Formula (1) is an inclined surface that is inclined with respect to a transverse plane of the column main body.

3. The column according to claim 2, wherein the first lid surface is a surface corresponding to a circumferential surface of a conical frustum having the first flow path as a center axis.

4. The column according to claim 1, wherein the second lid surface when the θ2 satisfies Formula (2) is an inclined surface that is inclined with respect to a transverse plane of the column main body.

5. The column according to claim 4, wherein the second lid surface is a surface corresponding to a circumferential surface of a conical frustum having the second flow path as a center axis.

6. The column according to claim 1, wherein the first partition wall and the second partition wall have liquid permeability.

7. The column according to claim 6, wherein the first partition wall and the second partition wall are filter members.

8. A column comprising:
a column main body that is tubular;
a first partition wall and a second partition wall that are disposed within the column main body and separated from each other along an axial direction of the column main body, the first partition wall and the second partition wall defining an adsorbent filling space therebetween;
a first lid defining a first space between the first lid and the first partition wall and having a first flow path communicating with the first space; and
a second lid defining a second space between the second lid and the second partition wall and having a second flow path communicating with the second space,
wherein
the first lid has a first lid surface facing the first space,
the second lid has a second lid surface facing the second space, and
when the first lid is located vertically above the second lid,
the first lid surface is inclined to approach a center in a length direction of the column main body from a center of the first lid surface toward an outer side thereof, and has an area of 100.40% or greater and 130.00% or less relative to a unit cross-sectional area of the column main body in a horizontal direction perpendicular to the length direction of the column main body, which occupies a region vertically below the first lid surface, or
the second lid surface is inclined to approach the center in the length direction of the column main body from a center of the second lid surface toward an outer side thereof, and has an area of 100.40% or greater and 130.00% or less relative to the unit cross-sectional area of the column main body in the horizontal direction perpendicular to the length direction of the column main body, which occupies a region vertically above the second lid surface.

9. An adsorption apparatus comprising:
the column described in claim 1; and
a powder of hydroxyapatite charged in the adsorbent filling space of the column.

10. The adsorption apparatus according to claim 9,
wherein the powder adsorbs a substance to be adsorbed when a sample solution containing the substance is supplied to the adsorbent filling space via the first flow path of the first lid in a state in which the first lid is located vertically above the second lid.

11. The adsorption apparatus according to claim 10, wherein
the substance is purified by supplying a buffer solution to the adsorbent filling space, and
the buffer solution is supplied to the adsorbent filling space at a rate of 40 cm/h or greater and 200 cm/h or less.

12. An adsorption apparatus comprising:
the column described in claim 8; and
a powder of hydroxyapatite charged in the adsorbent filling space of the column.

13. The adsorption apparatus according to claim 12,
wherein the powder adsorbs a substance to be adsorbed when a sample solution containing the substance is supplied to the adsorbent filling space via the first flow path of the first lid in a state in which the first lid is located vertically above the second lid.

14. The adsorption apparatus according to claim 13, wherein
the substance is purified by supplying a buffer solution to the adsorbent filling space, and
the buffer solution is supplied to the adsorbent filling space at a rate of 40 cm/h or greater and 200 cm/h or less.
